(19) United States
(12) Patent Application Publication
(10) Pub. No.: US 2020/0273494 A1
(43) Pub. Date: Aug. 27, 2020

(54) SYSTEM AND METHOD FOR AUTOMATED ASSEMBLY OF AUDIOVISUAL MONTAGE

(71) Applicant: Brendan Mee Law, P.C., South Orange, NJ (US)

(72) Inventors: Brendan Mee, South Orange, NJ (US); Kevin A. Delaney, Little Falls, NJ (US)

(73) Assignee: Brendan Mee Law, P.C., South Orange, NJ (US)

(21) Appl. No.: 16/283,788

(22) Filed: Feb. 24, 2019

(51) Int. Cl. G11B 27/036; H04M 1/02; G11B 27/00; H04N 9/87

(52) U.S. Cl. CPC G11B 27/036; H04M 1/0266; G06F 3/0482; H04N 9/87; H04M 2201/36; G11B 27/007

(57) ABSTRACT

An apparatus and method for generating an audiovisual montage from selected image files and audio files automates the creation of video clips based on the duration of the audio file. The video clips are concatenated into sequences and may be processed automatically according to a user-selected style to create a processed audiovisual montage suitable for sharing on social media with minimal user involvement.

### FIELD OF THE INVENTION

Embodiments of the invention relate to automated assembly and creation of audiovisual files from selected still image files and audio files.

### BACKGROUND OF THE INVENTION

Computer software and smartphone “apps” for editing video are well known. In virtually all cases, use of these software systems and apps begins by selecting pre-existing video or creating video to include in a finished video file. The pre-existing or created videos may include associated audio footage. The selected or created segments are organized, such as by logging, and then edited and assembled into a video file. An audio file may edited and “synched” to the video file to create an audiovisual work.

Several drawbacks exist with the current software systems and apps that render them inappropriate for use in many technological settings. Video files tend to be large, requiring extensive processing time. The level of expertise required to render video and the number of aesthetic decisions that must be made by a user to produce even a simple audiovisual work can be daunting to many users and impractical for many applications.

### SUMMARY OF THE INVENTION

Thus, it is an object of the present invention to simplify and automate the creation of audiovisual files from existing still images and audio files which may be performed for example on a smart phone without engaging significant video editing resources.

Another object of the invention is to allow a user who creates an audio file to share the audio file on a video file sharing application such as YouTube®, Instagram® and Facebook® quickly and easily without engaging conventional audiovisual resources. In this aspect, the invention may be embodied as a method for automatically creating an audiovisual montage, comprising displaying for user selection at least one audio file having a duration (such as, without limitation, a .WAV or .MP3 file) from at least a first user storage; receiving user selection of said audio file; displaying for user selection a plurality of still images (such as, without limitation, .PNG or .JPEG files) from another user storage and receiving user selection of said still images; determining, by a processor, a video clip duration based on the duration of the audio file; converting, by a processor, each selected still image into a video clip having said video clip duration; concatenating the video clips to form at least one video sequence; and combining the audio file and the at least one video sequence to create the audiovisual montage.

The invention is also embodied as a system for automatically creating an audiovisual montage (running, for example, on a user's smartphone), comprising: a processor configured to display options for selecting at least one audio file and at least one still image from user storage, receive input from a user selecting said audio file and still image; determine a duration of the audio file; calculate a video clip duration based on a duration of the audio file; convert each still image selected into a video clip having said video clip duration; concatenate the video clips into at least one video sequence; and combine the audio file and at least one video sequence to create the audiovisual montage.

In another aspect, the invention is a system running on a processor, and method for using the system, for automatically creating a themed audiovisual montage created from still images synchronized to an audio file selected by a user. In embodiments, the method comprises, by a processor: displaying and receiving a user selection of an identified style type; displaying and receiving an audio file and at least one still image file selected by a user; determining a duration of the audio file; calculating a video clip duration based on a duration of the audio file; converting each still image selected into a video clip having said video clip duration; concatenating the video clips into a video sequence; modifying the video sequence according to the style type, wherein said style type consists of a plurality of predetermined theme elements selected from the group consisting of: duration of video clip; sequence; transitions and fades; color effects and filters; titles; panning pattern and speed; and image add-ons; and combining the audio file and video sequence to create the audiovisual montage in a video format (such as, without limitation, MP4).

In another aspect one or more audiovisual files in a user's storage may be selected, without associated sound, and these images may be processed and synched with preexisting audio as described above. In this aspect, a processor, such as on a user's smart phone, presents image files for selection by a user, which may include (for example and not by way of limitation) PNG, JPEFG, and MP4 audiovisual files. If an audiovisual (MP4) file is selected, the processor disassociates the image from the audio component of the of file and generates a video clip having a duration based on the duration of the audiovisual file, as described herein. A video clip thus processed from the MP4 file is then may be concatenated with other video clips in one or more video sequences as would be a video clip processed from a still image.

### BRIEF DESCRIPTION OF THE DRAWINGS

The foregoing and other objects, features, and advantages of the present invention, as well as the invention itself, is more fully understood from the following description of various embodiments, when read together with the accompanying drawings.

FIG. 1 schematically illustrates a system for automatically generating audiovisual files according to an embodiment of the invention.

FIG. 2 is a flowchart of a method for automatically generating an audiovisual file from a selected audio file and selected series of images according to an embodiment of the invention.

### DETAILED DESCRIPTION OF THE INVENTION

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

“Audio file” as used herein includes compressed and uncompressed audio formats, now known or hereafter developed, which contain waveform data that can be played with audio playback software. Common audio file extensions include .WAV, .AIF, and .MP3. “Audio file” as used herein includes audio files that may be part of a video format such as .MP4 and .MOV files, with the understanding that only the audio component of such file is considered when referring to an “audio file”.

In embodiments, a video file may be substituted for a still image in the methods described herein, with the proviso that the video file substituted for a still image is not used with any native audio associated with the video file.

Method steps for achieving a result may be performed in any order to achieve the result, notwithstanding that the steps may be presented in a certain order. For example, the step of selecting an audio file may be performed before or after the step of selecting a series of still images to create a montage. It will be understood that both audio and video must be selected before the video clip(s) or video sequence(s) based on a duration of the audio file can be created.

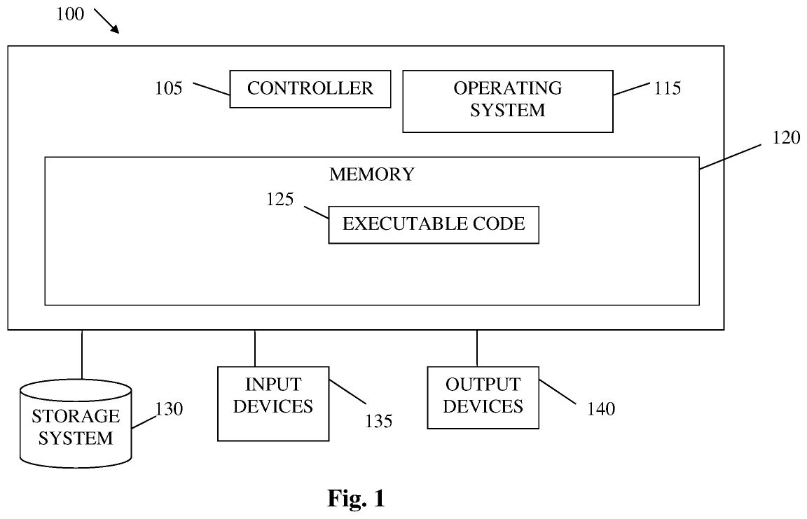

Reference is made to FIG. 1 which schematically illustrates a system 100 according to an embodiment of the invention wherein a hardware platform includes a CPU including controller 105, resident storage 130, transitory storage 120, input device(s) 135, output device(s) 140, a network interface and operating system 115. A specific example of a suitable hardware platform is a Samsung Galaxy S9 running Android OS 8.0, but it is to be understood that the teachings herein can be modified for other presently known or future hardware platforms. From the following detailed description. it will be apparent that all of the elements in FIG. 1 may be located in a single housing, such as a smart phone. However, it will be apparent that this need not be the case. External audio or video recording device(s) may be used as input devices and as resident storage. In a typical desktop computer application, input device(s) 135 such as keyboard, and other peripherals, and output device(s) 140, such as speakers and video display, and other peripherals, may be in a separate housing or location communicating with CPU loading executable code 125 in transitory memory 120. All of these arrangements are well within the skill of the person of ordinary skill in the art.

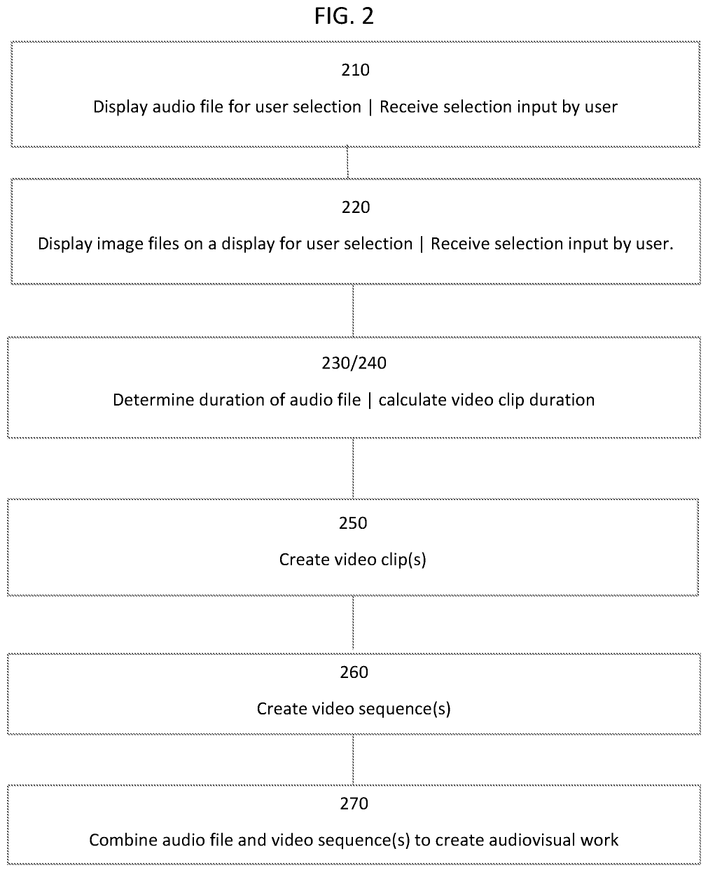

The software, described below, based on the flowchart shown in FIG. 2, is stored in the resident storage 120 and runs on the CPU, making use of the transitory and resident storage 120 as needed.

The flow chart of FIG. 2 depicts a system and method according to a first embodiment of the invention wherein a music video is prepared and posted on social media, using as inputs a single audio file and a plurality of image files residing on storage on the user's smart phone and selected by the user.

In step 210, the app prompts a user to select an audio file on the smart phone. The user selects an audio file. In this step, the user may navigate to the location of the desired audio file. The app may apply certain filters so that only files with a particular file extension or in a particular location are displayed to the user. Many such modifications are left to the preference of the programmer having ordinary skill in the art.

In an alternative embodiment, the app may prompt a user to record and save an audio file using resources on the smartphone or otherwise in operative communication with controller 105 and this creation will serve as selection step 210. The user may have options to accept or reject the recorded audio before selection.

In step 220, the app displays still image files on a display for selection by the user. By way of explanation and not limitation, still images may be in the form of PNG and JPEG files in user storage identified in thumbnail form in the user's “photo gallery”, for example.

In an alternative embodiment, controller 105 may prompt the user to take a photo using onboard resources on the smartphone or otherwise in operative communication with controller and this creation will serve as selection step 220. The user may have options to accept or reject the still images before selection.

In step 230, controller 105 determines an audio file duration. The audio file duration is used in subsequent steps to determine a video clip duration and aesthetic features of the finished audiovisual work which is the end product of the method according to the invention.

In step 240, controller 105 calculates a video clip duration based on a duration of the audio file. In embodiments, the video clip duration of each video clip is about equal. For example, if an audio file is three minutes long and the user selects three images from her smart phone for creation of the audiovisual montage, the duration of the video clips created from the individual still images may be equal to one another and each about one minute in duration. Calculating video clip duration may be based on a duration of the audio file in combination with other factors. For example, to implement more “cuts” in an audiovisual montage based on a user's selection of a “style”, as described below, the video clip duration allotted to each still image may be shorter, and the video clips may be repeated in one or more sequences. The video clips may be created with a duration of about 0.1 seconds to 59 seconds each, for example. Beginning and ending titles for the audiovisual montage, implemented as described below, may impact the calculation of the video clip duration. Transitions between video clips and implementation of other style elements may impact calculation of the duration of the video clips. In another embodiment, the duration of the audio file may be divided by a target duration of video clip to determine the number of times a single image must be repeated during the video montage. For example, if an audio clip has a duration of 1 minute, and a target duration of video clip is 1 second, a total of 60 clips will appear in the final montage. The processor determines that If 10 images are selected, each image having a duration of 1 second, each clip must be repeated 6 times (in an order determined by the processor). In embodiments, a target duration for a video clip is in a range of about 0.5 to about 10 seconds. From this data the processor calculates how many times each still image is repeated. In preferred embodiments, the calculation of video clip duration and creation of individual video clips is done according to a predetermined scheme, without input by the user.

The calculation of video clip duration based on the duration of the audio clip may result in variable video clip duration. Based on the audio file duration, different formulas may be applied to arrive at video clips having variable duration. For example, a mathematical series of n terms, wherein each term of the series represents a video clip duration, may be set equal to the duration of the audio file sequence, to arrive at a variable duration of video clips. Other techniques for arriving at a video clip duration based on the duration of the audio file and the number of distinct still images would be apparent to the person of ordinary skilled in the art, and a processor may be programmed to perform the calculations, whether it is dividing the video clip duration by some multiple of the number of selected still images or a more involved formula.

In step 250, selected still images are converted into video clips having the specified video clip duration and in step 260 the video clips are concatenated to form at least one video sequence. These steps may be combined. Sequences of video clips may be created and then the sequences concatenated by the processor to make audiovisual montage. Preferably, steps 250 and 260 are completed without user intervention and without displaying either the individual video clips or the at least one video sequence. Thus, the “editing” process is automated and invisible to the user. More than one video sequence may be created from the same set of videos clips. In the example above, with three video clips of equal length, six unique sequences are possible simply by changing the order. The video sequences may then be presented with video clips in different orders. The video sequences themselves may be concatenated to create more “cuts” in an audiovisual montage.

In step 260 transitions may be added between each clip and between video sequences, including dissolves, where one image gradually fades into another, sweep cuts—where the clips both appear in a different part of the screen for a period of time until one image gradually takes over more display space than the other—, jump cuts—where one image changes immediately to the other—and the like. Other transitions known in the art include “circle wipe”, “split and slide”, and “X-ray strobe”. In embodiments, the user merely selects a style and a predetermined transition is applied between video clips, or between video sequences in the audiovisual montage. In embodiments, both the selection of the actual transition and the insertion between video clips is invisible to the user.

In step 270 the audio file and the video sequence(s) are combined to create an audiovisual work having a duration of the audio file. In embodiments, the app permits sharing of the audiovisual work immediately to social media. In an embodiment, the audio file is shortened before the audiovisual work is generated to accommodate a social media platform that limits a length of an audiovisual work that may be uploaded. Alternatively, the audiovisual work may be automatically clipped after it is made, or at the time of upload, according to the requirements of social media website where the work will be shared. The user may have the option in such instance of cutting the beginning, cutting the end, or clipping both beginning and end of the video montage before it is uploaded.

In embodiments, selecting a theme for a video montage may be based on waveform analysis of the audio file, without input from the user.

Table 1 below depicts a matrix of theme elements which may be organized according to a predetermined style. Thus, a “style” is a predetermined selection of specific theme elements. A non-exclusive list of theme elements is depicted in Table 1 below. Other theme elements, known by those of skill in the art to define a style of video or still image editing may be included on a similar menu. A style, however, must include a predetermined selection of these elements so that a user is able to create an audiovisual work without making these individual aesthetic decisions. The theme elements in Table 1 are: duration of video clip; duration of sequence; order/repetition of video clips and sequences; transitions and fades; color; titles; panning pattern and speed; and image add-ons. These theme elements may be added to the video sequence when video clips are created in step 250 and/or when concatenated into a video sequence in step 260. In preferred embodiments, controller 105 displays a plurality of styles and a style may be selected by the user, representing a predetermined set of theme elements to provide a “look and feel” to the montage according to the predetermined set of elements without interaction by the user beyond selection of a specified style. Not all theme elements need to be selected to create a “style” and a particular style may include a null selection for certain theme elements. By way of illustration, a predetermined style may include the bolded theme elements in Table 1 below. By selecting a style, the user automatically initiates the required changes to the video clips and video sequence ultimately implemented in the audiovisual work.

TABLE 1

| THEME ELEMENT | OPTIONS | | | |
|---|---|---|---|---|
| DURATION OF VIDEO CLIP | SLOW | MEDIUM | FAST | VARIABLE |
| REPETITION | ORDERED | RANDOM | ORDERED | |
| | | | REPEATED | |
| TRANSITIONS AND FADES | DISSOLVE | SWEEP CUT | JUMP CUT | CIRCLE WIPE, |
| | | | | SPLIT AND SLIDE, |
| | | | | X-RAY STROBE, |
| | | | | ETC. |
| COLOR AND FILTERS | BLACK AND | HOME VIDEO | CINEMATIC | PSYCHEDELIC, |
| | WHITE | | | ETC. |
| TITLES | OPENING | AUTOMATIC OR | CLOSING | NONE |
| | | USER INPUT | | |
| | | (“OMG”; “LOOK | | |
| | | AT EM GO”) | | |
| PANNING PATTERN | TRACKING (, | ZOOM IN AND | TOP TO BOTTOM | |
| | | OUT | CORNERS TO | |
| | | | CENTER | |
| PANNING SPEED | SLOW | FAST | | |
| IMAGE ADD ONS | BORDERS | EMOTICONS | TEXT | OCCASIONAL |

As would be apparent to the video editor of ordinary skill in the art, theme elements may be associated with a specified look and feel. Thus, a succession of quick jump cuts is associated with an energetic mood, whereas a slow transition between still images that are held for a long period of time with gentle dissolves between them may be more readily associated with a relaxed or nostalgic mood. Likewise, a black and white color may be associated with historical footage, evincing a nostalgic mood, whereas a bright saturated color scheme tends to create a more urgent and cinematic mood. These moods could be reflected in the naming of the styles for the users convenience.

In this aspect, the invention resides no so much in the options available to a user—as most if not all of these options are known in the context of still image and video editing software, such as Adobe Photoshop® and Microsoft Movie Maker®, and most are known to even to less sophisticated users—an important feature of the invention is that theme elements are predetermined and applied automatically based on a limited number of user inputs, including duration of shots.

Titles may be entered by the user or created automatically. In embodiments, Titles are created automatically from a user name and an audio file name and a video clip containing the Title is generated automatically, when the user selects to “make video”. Alternatively, a user may access an interface, on a smart phone or otherwise, that permits entry of text for the opening and closing titles. Alternatively, stock text may be stored on the user's phone or remotely and may be overlaid on the audiovisual montage automatically based user's selection of a style. Such stock text may be grouped according to theme, such as birthdays and holidays, or random (“OMG, look at 'em go!”). (“here comes my favorite part”).

Although described herein primarily in connection with a smart phone, other platforms may be adapted for use with a system or method according to the invention. For example, the system may use a separate recording device which is accessed as the storage where the audio file resides. The user may cause a processor-equipped device to communicate with the recording device to display and select. A cable or blue tooth connection between a smart phone and a recording device may generate display and selection options automatically upon activation.

Image add-ons means visual elements that are added to the video clips. These may be emoticons and other visual images that can be added to a still image (and a resulting video clip), such as a frame around a border of the image, text additions, etc. Image modification features are known from still image and photo editing software, including but not limited to Adobe Photoshop®, however, processing these with existing still images selected by a user into video format, without significant input from the user, affords a simple way to create interesting audiovisual works with minimal resources and skill. Add-ons may be thematically organized (“occasional” in Table 1) according to a particular style for ease of selection and controlled selection by a user. Image add-ons or stickers includes frames and borders, for example. In embodiments, the user may have access to occasional libraries, based on St. Patrick's Day, Valentine's Day, Birthdays, Chanukah, and the like.

Add ons may reside in user storage, on a local device or in the cloud. In embodiments, add-ons may be purchased on-line as a function of selecting an image, so that the add on images may be selected and included in the audiovisual montage.

Panning refers to an effect whereby a video clip appears to track across a still image, including zooming in or out of an image. Different panning patterns and speeds may be associated with a given style selected by the user to make an audiovisual montage, while the implementation remains invisible to the user.

The description of the foregoing preferred embodiments is not to be considered as limiting the invention, which is defined according to the appended claims. The person of ordinary skill in the art, relying on the foregoing disclosure, may practice variants of the embodiments described without departing from the scope of the invention claimed. For example, although the Figures depict a particular configuration of side frame, consistent with AAR Standard M 976, embodiments of the invention may find utility with other truck designs. A feature or dependent claim limitation described in connection with one embodiment or independent claim may be adapted for use with another embodiment or independent claim, without departing from the scope of the invention.

1. A system for automatically generating an audiovisual montage from a single user-selected audio file and at least one user-selected image, comprising a display, user storage, and a processor configured to:
display options to a user on the display for the user to select at least one audio file and at least one still image from the user storage;
receive input from a user selecting said at least one audio file and said at least one still image;
determine a duration of the audio file;
calculate a video clip duration based on a duration of the audio file;
convert each still image selected into a video clip having said video clip duration;
concatenate the video clips into a video sequence; and
combine the audio file and video sequence to create the audiovisual montage.

2. The system according to claim 1, wherein the processor and said user storage are housed in a smart phone.

3. The system according to claim 1, wherein at least one user storage is remote from the processor.

4. The system according to claim 3, wherein at least one user storage is in the cloud.

5. The system according to claim 1, further comprising a camera adapted to create a still image for selecting by the user.

6. The system according to claim 1, further comprising a sound recorder adapted to create an audio file for selecting by the user.

7. The system according to claim 1, wherein the processor is configured to apply theme elements to modify the audiovisual montage, said theme elements selected from the group consisting of: duration of video clip; sequence of video clips; transitions and fades; color effects and filters; titles; panning pattern and speed; and image add-ons; and combining the audio file and video sequence to create the audiovisual montage in a video format; and wherein
the theme elements are organized into a predetermined style defined as a specified combination of theme elements.

8. The system according to claim 1, wherein the process is configured to repeat the video sequence to create the audiovisual montage.

9. A method for automatically generating an audiovisual montage from a user-selected audio file and at least one user-selected still image, comprising:
displaying at least one audio file and at least one still image to a user on a display;
receiving input from a user selecting an audio file from at least a first storage;
receiving input from a user selecting a plurality of still images from a second user storage;
determining a duration of the audio file;
calculating a video clip duration based on the duration of the audio file;
converting each selected still image into a video clip having said video clip duration;
concatenating the video clips to form a video sequence; and
combining the audio file and the video sequence to create the audiovisual montage.

10. The method according to claim 9, wherein the video clip duration is variable.

11. The method according to claim 9, wherein the video clips all have the same duration.

12. The method according to claim 9, wherein calculating a video clip duration based on the duration of the audio file is further based on user selection of an audiovisual montage style defined as a predetermined selection of theme elements selected from the group consisting of duration of video clip; sequence of video clips; transitions and fades; color effects and filters; titles; panning pattern and speed; and image add-ons.

13. The method according to claim 9, wherein displaying at least one audio file and at least one still image to a user on a display includes displaying an option to obtain the audio file and/or the at least one still image with at least one on board recording device.

14. The method according to claim 9, comprising accessing an audio file, image files or image add-ons from user storage remote from the display.

15. The method according to claim 14, wherein the image add-ons are grouped according to a theme or style.

16. The method according to claim 9, further comprising displaying a video file to a user for selection, receiving a user's section of the video file, processing the video file to remove associated audio and preparing from the video file a video clip having a duration based on the duration of the audio file, and including the video clip processed from a video clip in the audiovisual montage.

17. The method according to claim 9, wherein user storage includes image add-ons displayed to the user and selected by the user.

18. A method for automatically generating an audiovisual montage from a user-selected audio file and at least one user-selected still image, having a predetermined combination of theme elements comprising:
displaying to a user on a display a plurality of styles, wherein a single style of the plurality of styles is selectable by the user,
displaying at least one audio file and at least one still image to the user on the display;
receiving input from a user selecting an audio file from at least a first storage;
receiving input from a user selecting a plurality of still images from a second user storage;
determining a duration of the audio file;
calculating a video clip duration based on the duration of the audio file;
converting each selected still image into a video clip having said video clip duration;
concatenating the video clips to form a video sequence; and
combining the audio file and the video sequence to create the audiovisual montage.
